(19) United States
(12) Patent Application Publication
(10) Pub. No.: US 2004/0000414 A1
(43) Pub. Date: Jan. 1, 2004

(54) Method of manufacturing a percussion mechanism of a hand-held power tool

(76) Inventors: Karl Echtler, Puchheim (DE); Lutz Troeder, Turkenfeld (DE); Martin Richter, Freising (DE); Stefan Wanninger, Monchengladbach (DE)

Correspondence Address: SIDLEY AUSTIN BROWN & WOOD LLP, 787 Seventh Avenue, New York, NY, 10019, US

(21) Appl. No.: 10/411,165

(22) Filed: Apr. 10, 2003

(30) Foreign Application Priority Data
Apr. 11, 2002 (DE) 102 16 051.1

(51) Int. Cl. B25D 9/00

(52) U.S. Cl. 173/201

(57) ABSTRACT

A percussion mechanism of a hand-held power tool includes a reciprocating percussion piston (1) displaceable under the action of a pneumatic spring (5) to apply blows to an end surface of a working tool (8), which is received in a chuck (7) of the power tool, directly or via an anvil (6), with the percussion piston (1) and/or the anvil (6), when the anvil is used, being formed of a non-ferromagnetic material.

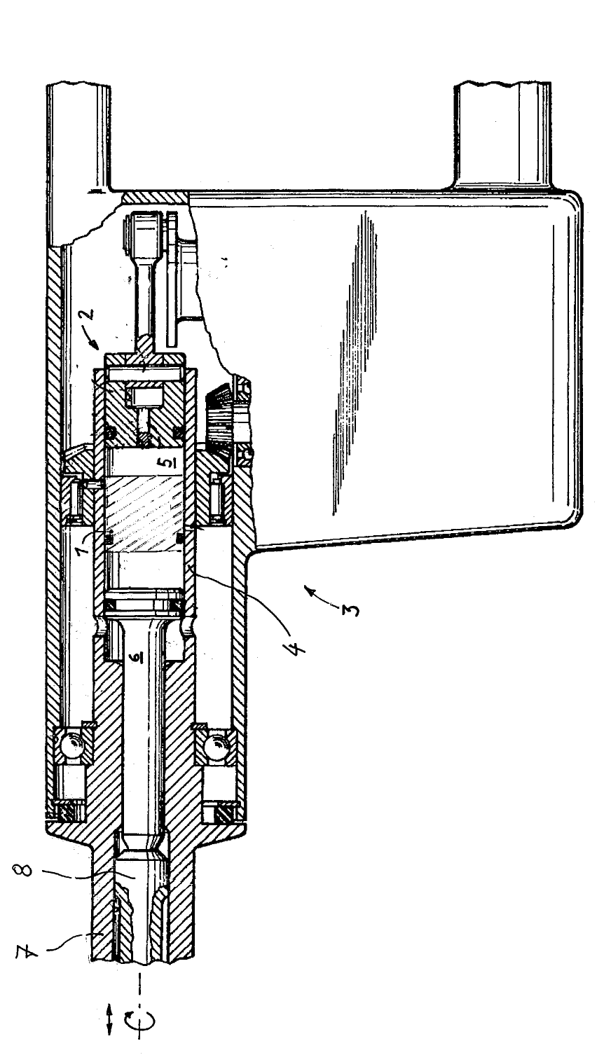

### BACKGROUND OF THE INVENTION

1. Field of the Invention

The present invention relates to percussion mechanism of a hand-held power tool which includes a reciprocating percussion piston displaceable under the action of a pneumatic spring to apply blows to an end surface of a working tool, which is received in a chuck of the power tool, directly or via an anvil. The present invention also relates to a method of forming the percussion mechanism.

2. Description of the Prior Art

Generally, a percussion mechanism of an electrical hand-held tool or of another type of a power tool includes a percussion piston displaceable in a guide tube under action of a pneumatic spring. The percussion piston applies blows to an anvil which transmits the blows to an end surface of a working tool received in a chuck of the power tool. The percussion piston and the anvil are usually formed of steel, whereby an adequate high density necessary for generating blow pulses and a high ductility and rigidity is obtained.

When a hand-held power tool is used in an environment with strong, in particular, static magnetic fields, e.g., in vicinity of aluminum smelting plants, and has a percussion mechanism with conventional percussion piston and/or anvil formed of an ferromagnetic material such as steel, there is a danger that the magnetic field that passes through the percussion mechanism, would cause a magnetically induced sticking of the percussion piston, in particular, in its initial position, and a predetermined use of the percussion mechanism would be distorted or completely prevented.

A pneumatic percussion mechanism of an electrical hand-held tool and including a percussion piston displaceable in a guide tube under the action of a pneumatic spring and formed of steel, is disclosed in U.S. Pat. No. 2,283,292.

U.S. Pat. Nos. 3,114,421 and 4,602,689 disclose a percussion piston an impacting region of which is formed as a cylindrical insert made of another, suitable for transmitting blows, material. U.S. Pat. No. 4,602,689 discloses forming the core of the percussion piston, which is particularly stressed as a result of applying blows, of a material heavier than steel. Such multi-part percussion pistons have, because of deterioration caused by blows, a reduced service life. In addition, such percussion pistons are costly in manufacturing.

An object of the present invention is a percussion mechanism suitable for use in an environment with strong magnetic fields.

### SUMMARY OF THE INVENTION

This and other objects of the present invention, which will become apparent hereinafter, are achieved by providing a percussion mechanism with a percussion piston and/or the anvil formed of a non-ferromagnetic, preferably hardenable material.

The formation of the one-piece percussion piston and/or anvil of a non-ferromagnetic material permits to insure a complete functionality of the percussion mechanism in an environment with strong magnetic fields, while increasing the service life of the percussion mechanism.

The physical phenomena, which lead to sticking of the percussion piston, which is formed of a ferromagnetic material, are not totally clear at present. They may lie in a complete or local magnetization of adhering components which bear against each other under an impact load, and in attraction of divergent magnetic field components to the outer surfaces of the associated ferromagnetic components which are permeated by a strong magnetic flux. However, the forces, which acts on paramagnetic components, are relatively small. Thus, forming even at least one of cooperating components of a non-ferromagnetic material permits to eliminate the sticking phenomenon.

Advantageously, the used, non-ferromagnetic material has substantially the same density and/or ductility as steel. As a non-ferromagnetic material, a steel alloy such as a conventional chrom-nickel-iron alloy, e.g. V2A or V4A, or a hardenable alloy, such as X90CoMoV18, can be used. The components formed of these materials insure practically the same dynamics of a percussion mechanism as components made of steel. This is very technologically advantageous.

Advantageously, the guide tube, in which the percussion piston is displaceable, is likewise formed of a non-ferromagnetic material, preferably, a diamagnetic material such as a magnesium-aluminum alloy, which still further reduces the danger of sticking of the percussion piston.

A hand-held power tool, a percussion mechanism of which has some or all of its components formed of a non-magnetic material, can be used in an environment with very strong magnetic fields.

The novel features of the present invention, which are considered as characteristic for the invention, are set forth in the appended claims. The invention itself, however both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

Single figure of the drawing shows a cross-sectional view of a percussion mechanism according to the present invention.

### DETAILED DESCRIPTION OF THE PREFERRED EMBODIMENTS

A percussion mechanism according to the present invention, which can represent, e.g. a percussion mechanism of a conventional electrical hand-held tool formed as an all-purpose hammer, includes a percussion mechanism (2) having a reciprocating percussion piston (1) that reciprocates under action of a pneumatic spring (5) in a guide tube (4) formed, e.g., of a magnesium-aluminum alloy. The percussion piston (1) impacts an anvil (6) which, in turn, impacts an end surface of a working tool (8) such as, e.g., a chisel that is received in a chuck (7) of the electrical hand-held tool. According to the present invention, the percussion piston (1) and the anvil, (6) which have the same geometry as the percussion piston and anvil of a conventional percussion mechanism, are made of a non-ferromagnetic chrom-nickel-steel alloy in contrast to the percussion piston and anvil of the conventional percussion mechanism which are made of a ferromagnetic steel.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claim is:

1. A percussion mechanism for a hand-held power tool, comprising a reciprocating percussion piston (1) for applying blows to an end surface of a working tool (8) received in a chuck (7) of the power tool; and a pneumatic spring (5) for displacing the percussion piston (1),
wherein the percussion piston (1) is formed as a one-piece part of a non-magnetic material.

2. A percussion mechanism for a hand-held power tool, comprising a one-piece reciprocating percussion piston (1) for generating blows; an anvil (b) located in front of the percussion piston (1) in an operational direction of the power tool for transmitting blows to an end surface of a working tool (8) received in a chuck (7) of the power tool; and a pneumatic spring (5) for displacing the percussion piston (1),
wherein at least one of the percussion piston (1) and the anvil (6) is formed of a non-ferromagnetic material.

3. A percussion mechanism according to claim 2, wherein the non-ferromagnetic material has at least one of density and ductibility similar to one of density and ductibility of steel, respectively.

4. A percussion mechanism according to claim 3, wherein the non-ferromagnetic material is a non-ferromagnetic steel alloy.

5. A percussion mechanism according to claim 4, wherein the non-ferromagnetic steel alloy is a hardenable alloy.

6. A percussion mechanism according to claim 2, wherein both the percussion piston (1) and the anvil (6) are formed of a non-ferromagnetic alloy.

7. A percussion mechanism according to claim 2, further comprising a guide tube (4) in which the percussion piston is displaceable.

8. A percussion mechanism according to claim 7, wherein the guide tube (4) is formed of a non-ferromagnetic material.

9. A percussion mechanism according to claim 8, wherein the guide tube (4) is formed of a diamagnetic material.

10. A method of manufacturing of a percussion mechanism of a hand-held tool and including a reciprocating percussion piston displaceable under an action of a pneumatic spring for applying blows to an end surface of a working tool received in a chuck of the hand-held tool, the method comprising the step of forming the percussion piston, which is formed as a one-piece part, of a non-ferromagnetic material.

11. A method according to claim 10, wherein the forming step comprises forming the percussion piston of the non-ferromagnetic material having at least one of density and ductility similar to that of steel.

12. A method according to claim 11, wherein the forming step comprising forming the percussion piston of a steel alloy used as the non-ferromagnetic material.

13. A method according to claim 12, wherein the forming step includes forming the percussion piston of a hardenable steel alloy.

14. A method according to claim 10, wherein the percussion mechanism has an anvil for transmitting the blows, which are produced as a result of reciprocating movement of the percussion piston, to the end surface of the working tool, the method further comprising the step of forming the anvil of a non-ferromagnetic material.

15. A method according to claim 10, wherein the percussion mechanism further comprises a guide tube in which the percussion piston is displaceable, the method further comprising the step of forming the guide tube of a non-ferromagnetic material.

16. A method according to claim 15, wherein the guide tube forming step comprises forming the guide tube of a diamagnetic material used as the non-ferromagnetic material.
